(19) United States
(12) Patent Application Publication
(10) Pub. No.: US 2018/0218267 A1
(43) Pub. Date: Aug. 2, 2018

(54) SOLVING GOAL RECOGNITION USING PLANNING

(71) Applicant: International Business Machines Corporation, Armonk, NY (US)

(72) Inventors: Nagui Halim, Yorktown Heights, NY (US); Anton Viktorovich Riabov, Ann Arbor, MI (US); Shirin Sohrabi Araghi, Port Chester, NY (US); Octavian Udrea, Ossining, NY (US)

(21) Appl. No.: 15/840,523

(22) Filed: Dec. 13, 2017

Related U.S. Application Data
(63) Continuation of application No. 15/420,929, filed on Jan. 31, 2017.

(51) Int. Cl. G06N 5/02; G06N 99/00; G06N 7/00

(52) U.S. Cl. CPC G06N 5/022; G06N 99/005; G06N 7/005

(57) ABSTRACT

Techniques are provided for recognizing goals using an artificial intelligence planner, a model of a domain, a set of observations associated with the domain, and a set of possible goals. In one example, a computer-implemented method comprises, in response to receiving a set of possible goals of an agent, a model of a domain, and a set of observations associated with the domain, transforming, by a system operatively coupled to a processor, a goal recognition problem into an artificial intelligence planning problem; determining, by the system, a set of plans using an artificial intelligence planner on the artificial intelligence planning problem; and determining, by the system, a probability distribution over the set of possible goals based on the set of plans.

### BACKGROUND

The subject disclosure relates generally to the problem of goal recognition by intelligent systems, and more specifically, to solving goal recognition using planning.

Conventional systems have employed plan recognition problems in which a plan library and a set of goals is given as input in order to rank the goals. Plan recognition is the problem of recognizing the plans and the goals of an agent given a set of observations. Goals can be ranked according to the order of which the system believes they were being pursued or more specially a probability distribution over the set of goals can be determined.

A planning problem generally comprises the following main elements: a finite set of facts, the initial state (a set of facts that are true initially), a finite set of action operators (with precondition and effects), and a goal condition. An action operator maps a state into another state. In classical planning, the objective is to find a sequence of action operators (or planning action) that, when applied to the initial state, will produce a state that satisfies the goal condition. This sequence of action operators is called a plan.

For example, as described in Ramirez, M., and Geffner, H., Plan Recognition as Planning, Proceedings of the 21^{st} International Joint Conference on Artificial Intelligence (IJCAI), 1778-1783 (2009): “[f]or this, we move away from the plan recognition problem over a plan library and consider the plan recognition problem over a domain theory and a possible set G of goals.” In another example, as described in Ramirez, M., and Geffner, H. 2010, Probabilistic Plan Recognition Using Off-The-Shelf Classical Planners, Proceedings of the 24th National Conference on Artificial Intelligence (AAAI) (2010): “[t]he goal of this work is to introduce a more general formulation that retains the benefits of the generative approach to plan recognition while producing posterior probabilities P(G|O) rather than boolean judgments.” However, the publications of Ramirez et al. do not present solutions for cases in which a set of mutually exclusive goals are not given as input. Also, the publications of Ramirez et al. do not address observations are reliable (not noisy, missing, inconsistent). Furthermore, the publications of Ramirez et al. do not present solutions that address observations over the state.

In a further example, as described in Jianxia Chen, Yixin Chen, You Xu, Ruoyun Huang, Zheng Chen, A Planning Approach to the Recognition of Multiple Goals, International Journal On Intelligence Systems 28(3): 203-216 (2013): “[i]n this paper, we present a novel logic-based approach to solve the multigoal recognition problem efficiently, without the need of plan libraries, using a state-of-the art heuristic search planner LAMA.” However, Chen et al. does not address unreliable observations and partial incomplete set of goals. Additionally, Chen et al. does not present solutions that address observations over the state.

Significantly, conventional systems do not adequately address several possible scenarios. For example, they do not address cases in which there is only a partial set of possible goals given to the system. In another example, they do not address cases in which an agent is pursuing only one goal, which is mutually exclusive from the other goals, or the agent is pursing multiple goals. Furthermore, they do not address cases in which one or more goals are pursued by more than one agent. In addition, one or more observations can be unreliable, such as being noisy, inconsistent, missing, defective, erroneous, or unreliable an any other suitable manner. Moreover, it is often the case that the actions are not directly observable, but their effects through the change in the state of the world are observable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. One or more embodiments described herein include a system, computer-implemented method, and/or computer program product, in accordance with the present invention.

According to an embodiment, a system is provided. The system comprises a memory that stores computer executable components; and a processor that executes the computer executable components stored in the memory. The computer executable components can comprise: a transformation component that transforms a goal recognition problem into an artificial intelligence planning problem, wherein the goal recognition problem is associated with a set of possible goals of an agent, a model of a domain, and a set of observations associated with the domain; a plan component that determines a set of plans using an artificial intelligence planner on the artificial intelligence planning problem; and a goal probability distribution component that determines a probability distribution over the set of possible goals based on the set of plans. This provides several benefits over prior art. One benefit of using a model of a domain is that plan libraries are not required. Another benefit is a set of plans are recognized, such as a plan comprising the whole sequence of events/actions that an agent might have done that are consistent with the set of observations.

The computer executable components can also comprise an observation component that: obtains the set of observations from one or more data sources; determines that one or more observations are unreliable; and discards the one or more observations that are unreliable. This provides a benefit over prior art in that unreliable observations are addressed when determining the set of plans.

The computer executable components can also comprise an observation component that: obtains the set of observations from one or more data sources; determines that one or more observations are action conditions; and translates the one or more observations that are action conditions into fluents. This provides a benefit over prior art in that unreliable observations are over fluents (e.g., states), not necessarily specific to an agent or actions of an agent.

In another embodiment, a computer-implemented method is provided. The computer-implemented method can include, in response to receiving a set of possible goals of an agent, a model of a domain, and a set of observations associated with the domain, transforming, by a system operatively coupled to a processor, a goal recognition problem into an artificial intelligence planning problem; determining, by the system, a set of plans using an artificial intelligence planner on the artificial intelligence planning problem; and determining, by the system, a probability distribution over the set of possible goals based on the set of plans. This provides several benefits over prior art. One benefit of using a model of a domain is that plan libraries are not required. Another benefit is a set of plans are recognized, such as a plan comprising the whole sequence of events/actions that an agent might have done that are consistent with the set of observations.

The computer-implemented method can also include, in response to determining that the set of possible goals comprises sequentially dependent goals, employing, by the system, a predicate representative of a done condition for one or more combinations of possible goals in the set of possible goals to determine the set of plans using the artificial intelligence planner on the artificial intelligence planning problem. This provides a benefit over prior art in that multiple goals that can be sequentially dependent goals can be automatically recognized.

The computer-implemented method can also include, in response to determining that the set of possible goals comprises sequentially independent goals, transforming, by the system, the goal recognition problem into respective artificial intelligence planning problems for possible goals in the set of possible goals, and employing, by the system, respective distinct predicates representative of a done condition for the artificial intelligence planning problems to determine sets of plans using the artificial intelligence planner on the artificial intelligence planning problems. This provides a benefit over prior art in that multiple goals that can be sequentially independent goals can be automatically recognized.

In another embodiment, a computer program product for recognizing goals is provided. The computer program product can include a computer readable storage medium having program instructions embodied therewith. The program instructions can be executable by a processer to cause the processer to: obtain a model of a domain; obtain a set of observations associated with the domain; obtain a set of possible goals of an agent operating in the domain; transform a goal recognition problem into an artificial intelligence planning problem, wherein the goal recognition problem is associated with the set of possible goals of the agent, the model of a domain, and the set of observations associated with the domain; determine a set of plans using an artificial intelligence planner on the artificial intelligence planning problem; and determine a probability distribution over the set of possible goals based on the set of plans. This provides several benefits over prior art. One benefit of using a model of a domain is that plan libraries are not required. Another benefit is a set of plans are recognized, such as a plan comprising the whole sequence of events/actions that an agent might have done that are consistent with the set of observations.

The program instructions executable by the processor can further cause the processor to, in response to a determination that the set of possible goals is a partial set of possible goals, obtain a future time horizon for determining the set of plans and obtain a threshold for clustering; and wherein the determination of the set of plans using the artificial intelligence planner on the artificial intelligence planning problem comprises a determination of the set of plans within the future time horizon. This provides a benefit over prior art in that goals can be automatically recognized when only a partial set of possible goals are provided.

The program instructions executable by the processor can further cause the processor to generate clusters of plans of the set plans using the threshold for clustering; and determine a set of other possible goals based on the clusters of plans. This provides a benefit over prior art in that when only a partial set of possible goals are provided, other possible goals not included in the partial set of possible goals can also be automatically recognized.

In another embodiment, a computer program product for recognizing goals is provided. The computer program product can include a computer readable storage medium having program instructions embodied therewith. The program instructions can be executable by a processer to cause the processer to: transform a goal recognition problem into an artificial intelligence planning problem, wherein the goal recognition problem is associated with a set of possible goals of an agent, a model of a domain, and a set of observations associated with the domain; determine a set of plans using an artificial intelligence planner on the artificial intelligence planning problem; and determine a probability distribution over the set of possible goals based on the set of plans. This provides several benefits over prior art. One benefit of using a model of a domain is that plan libraries are not required. Another benefit is a set of plans are recognized, such as a plan comprising the whole sequence of events/actions that an agent might have done that are consistent with the set of observations.

In another embodiment, a computer-implemented method is provided. The computer-implemented method can include obtaining, by a device operatively coupled to a processor, a model of a domain; obtaining, by the device, a set of observations associated with the domain; obtain a set of possible goals of an agent operating in the domain; transforming, by the device, a goal recognition problem into an artificial intelligence planning problem, wherein the goal recognition problem is associated with the set of possible goals of the agent, the model of a domain, and the set of observations associated with the domain; determining, by the device, a set of plans using an artificial intelligence planner on the artificial intelligence planning problem; and determining, by the device, a probability distribution over the set of possible goals based on the set of plans. This provides several benefits over prior art. One benefit of using a model of a domain is that plan libraries are not required. Another benefit is a set of plans are recognized, such as a plan comprising the whole sequence of events/actions that an agent might have done that are consistent with the set of observations.

### BRIEF DESCRIPTION OF THE DRAWINGS

FIG. 1 illustrates a block diagram of an example, non-limiting system in accordance with one or more embodiments described herein.

FIG. 2 illustrates a block diagram of an example, non-limiting, plan projector component in accordance with one or more embodiments described herein.

FIG. 3 illustrates a block diagram of an example, non-limiting, artificial intelligence planning component in accordance with one or more embodiments described herein.

FIG. 4 illustrates a block diagram of an example, non-limiting, plan projector component in accordance with one or more embodiments described herein.

FIG. 5 illustrates a flow diagram of an example, non-limiting computer-implemented method in accordance with one or more embodiments described herein.

FIG. 6 illustrates a flow diagram of another exemplary, non-limiting computer-implemented method in accordance with one or more embodiments described herein.

FIG. 7 illustrates a flow diagram of another exemplary, non-limiting computer-implemented method in accordance with one or more embodiments described herein.

FIG. 8 illustrates a flow diagram of an example, non-limiting computer-implemented method in accordance with one or more embodiments described herein.

FIG. 9 illustrates a flow diagram of another exemplary, non-limiting computer-implemented method in accordance with one or more embodiments described herein.

FIG. 10 illustrates a block diagram of an example, non-limiting operating environment in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident; however in various cases, that the one or more embodiments can be practiced without these specific details.

Goal recognition is the problem of recognizing one or more goals given knowledge about a domain and a set of observations with respect to one or more agents (e.g., a human, a robot, a program, or any other suitable agent) operating in the domain.

Goal recognition is an important problem with many applications, such as in a non-limiting example, intrusion detection and assisted cognition. To illustrate the goal recognition problem, consider tracking agent's locations (e.g., also their goals). Given a list of possible locations the agent can get to, and a set of observations (e.g., confirmed credit card charges, camera views, etc), the system would like to detect or predict the agent's destination location(s). Note, the agent's goal can be more than just the agent's destination location(s), but in this example, we are assuming it is a simple destination location recognition. Conventional systems assume that the list of possible destination locations is given and this list is mutually exclusive. That is, the agent is going to only one destination location. This is limiting because while an agent cannot be in two locations at the same time, it is possible that they travel to multiple destination locations in a same day or within a short time interval. Advantageously, embodiments disclosed herein can consider a combination of destination locations as a possible goal when recognizing goals. That is, one or more embodiments herein can improve coverage of goal recognition by lifting the assumption that an agent is pursing only one goal.

In another non-limiting example, consider the following energy domain example, where the objective is to project the price of oil and volume of oil produced 15 years into the future. Note, the objective is not to find a precise estimate of the price of oil, but rather to project the possible range of values, as well as provide explanations that lead to those values. A Planning Projector relies on domain knowledge that can either be provided by domain experts, or encoded by non-experts after reviewing various sources of available knowledge, such as research papers, textbooks, Wikipedia, or other suitable data sources. The domain knowledge in this example would describe possible actions affecting oil price directly or indirectly, for example by affecting supply levels. For instance, the decision of the leaders of OPEC (Organization of the Petroleum Exporting Countries) to meet is an action that is likely to affect both the price and the supply of oil, depending on the outcome of such a meeting. The decision to limit production will decrease the supply and increase the price, or the decision to increase supply can lead to lower prices. The observations associated with these actions, confirming or contradicting them, can be derived from news reports. Similarly, several other events or actions can be modeled, such as the discovery of a new oil field, drilling activity in known fields, hurricanes or other natural disasters affecting oil production, and changes in currency rates. This problem can be thought of as a goal recognition problem, where analysts do not know the full space of possibilities (e.g., goals), but can provide some estimates. Advantageously, one or more embodiments disclosed herein can use these partial goal descriptions but also come up with other potential goals that were not given to solve the goal recognition problem.

Another non-limiting example is a room in a home where an agent is making breakfast, lunch or dinner, and the agent's actions such as taking a spoon, or toasting a bread are observable. The problem to be solved is to detect the agent's one or more goals, and in a cognitive assistant setting, possibly intervene and help them in achieving the goals. While normally, an agent is making a meal for either breakfast, lunch or dinner, it is possible that the agent is interested in combining two meals and skipping a meal, or be creative in their choice of food. Conventional systems having restrictions on the set of goals, and/or that the agent is only pursing one goal can reduce the coverage of the goal recognition. Advantageously, one or more embodiments disclosed herein can consider a combination of goals and operate when only given a partial set of possible goals when recognizing goals.

To address the challenges in goal recognition as described herein, one or more embodiments of the invention can perform goal recognition using an artificial intelligence (AI) planner and domain theory in stark contrast to the convention systems usage of plan libraries. Furthermore, one or more exemplary embodiments of the invention can perform goal recognition when only a partial set of possible goals is given versus the requirement of conventional systems to be provided a complete set of possible goals. Additionally, one or more embodiments of the invention can perform goal recognition where the agent is pursuing multiple goals, where conventional systems operate on the assumption that the set of given possible goals are mutually exclusive and that the agent is only pursing one. Moreover, one or more exemplary embodiments of the invention can perform goal recognition when one or more observations can be unreliable, while conventional systems operate on the assumption that the observations are reliable. In addition, one or more exemplary embodiments of the invention can perform goal recognition while addressing observations that are over both actions and states (e.g., fluents), as opposed to conventional systems that only address actions.

One or more embodiments of the subject disclosure is directed to computer processing systems, computer-implemented methods, apparatus and/or computer program products that facilitate efficiently, effectively, and automatically (e.g., without direct human involvement) recognizing one or more goals of one or more agents operating in a domain. The computer processing systems, computer-implemented methods, apparatus and/or computer program products can employ hardware and/or software to solve problems that are highly technical in nature (e.g., adapted to perform automated goal recognition, adapted to generate and/or employ one or more different detailed, specific and highly-complex models) that are not abstract and that cannot be performed as a set of mental acts by a human. For example, a human, or even thousands of humans, cannot efficiently, accurately and effectively manually gather and analyze thousands of data elements related to a variety of observations in a real-time network based computing environment to recognize one or more goals of one or more agents operating in a domain. One or more embodiments of the subject computer processing systems, methods, apparatuses and/or computer program products can enable the automated generation of high quality plans based on domain models and observations using artificial intelligence planning in a highly accurate and efficient manner to recognize one or more goals. By employing domain models and artificial intelligence planning, the processing time and/or accuracy associated with the automated goal recognition systems is substantially improved. Additionally, the nature of the problem solved is inherently related to technological advancements in artificial intelligence based goal recognition that have not been previously addressed in this manner. Further, one or more embodiments of the subject techniques can facilitate improved performance of automated goal recommendation that provides for more efficient usage of storage resources, processing resources, and network bandwidth resources to provide highly granular and accurate recognized goals based on domain models and observations using artificial intelligence planning. For example, by allowing for partial set of possible goals as input and not requiring plan libraries, wasted usage of processing, storage, and network bandwidth resources can be avoided by mitigating the need to obtain this information.

In a non-limiting example, a domain can include domain knowledge regarding an industry, a field of study, an activity, an organization, an environment, a geographic area, a building, a vehicle, a room, or any other suitable definition of a domain. In artificial intelligence planning domain, the domain includes initial state, set of possible fluents, and set of possible actions. The planning domain is often encoded in Planning Domain Definition Language (PDDL).

By way of overview, aspects of systems, apparatuses, or processes in accordance with the present invention can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

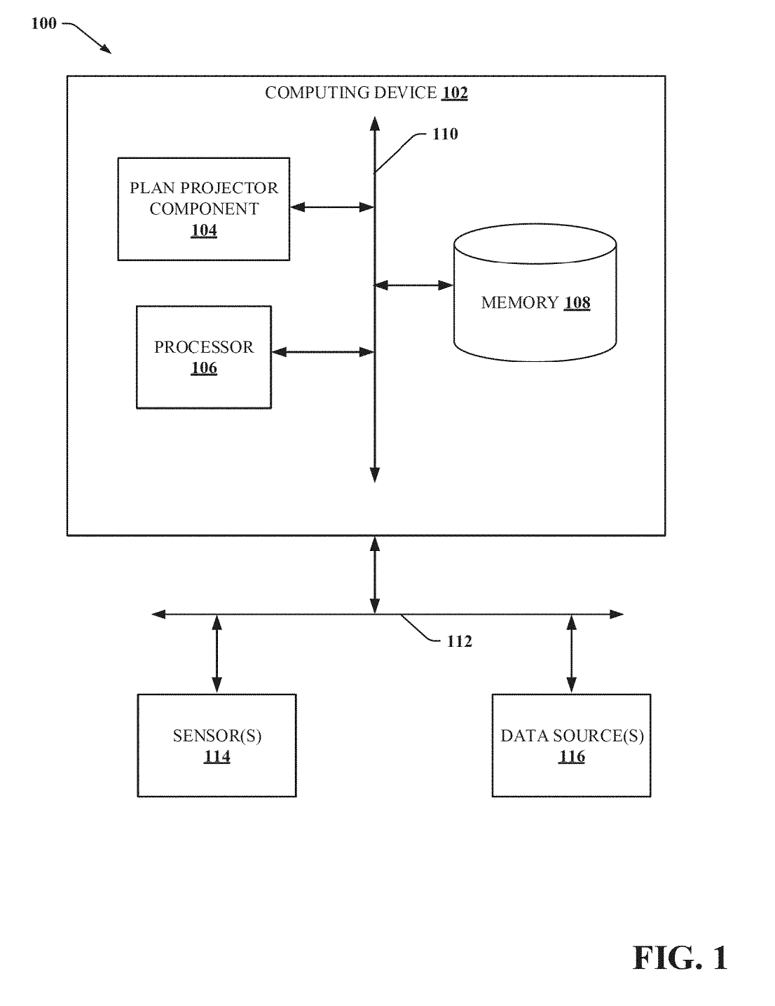

FIG. 1 illustrates a block diagram of an example, non-limiting system 100 that facilitates automatically recognizing one or more goals of one or more agents operating in a domain in accordance with one or more embodiments described herein. Repetitive description of like elements employed in one or more embodiments described herein is omitted for sake of brevity.

As shown in FIG. 1, the system 100 can include a computing device 102, one or more networks 112, one or more sensors, and one or more data sources 116. Computing device 102 can include a plan projector component 104 that can facilitate automatically recognizing one or more goals of one or more agents operating in a domain. Computing device 102 can also include or otherwise be associated with at least one included memory 108 that can store computer executable components (e.g., computer executable components can include, but are not limited to, the plan projector component 104 and associated components), and can store any data generated by plan projector component 104 and associated components. Computing device 102 can also include or otherwise be associated with at least one processor 106 that executes the computer executable components stored in memory 108. Computing device 102 can further include a system bus 110 that can couple the various server components including, but not limited to, the plan projector component 104, memory 108 and/or processor 106.

Computing device 102 can be any computing device that can be communicatively coupled to one or more sensors and/or one or more data sources 116, non-limiting examples of which can include, but are not limited to, include a wearable device or a non-wearable device Wearable device can include, for example, heads-up display glasses, a monocle, eyeglasses, contact lens, sunglasses, a headset, a visor, a cap, a mask, a headband, clothing, or any other suitable device that can be worn by a human or non-human user. Non-wearable device can include, for example, a mobile device, a mobile phone, a camera, a camcorder, a video camera, laptop computer, tablet device, desktop computer, server system, cable set top box, satellite set top box, cable modem, television set, monitor, media extender device, blu-ray device, DVD (digital versatile disc or digital video disc) device, compact disc device, video game system, portable video game console, audio/video receiver, radio device, portable music player, navigation system, car stereo, a mainframe computer, a robotic device, a wearable computer, an artificial intelligence system, a network storage device, a communication device, a web server device, a network switching device, a network routing device, a gateway device, a network hub device, a network bridge device, a control system, or any other suitable computing device 102. A sensor 114 can include any suitable device that performs a sensing function, non-limiting examples of which include a communication device, a radio frequency identification (RFID) reader, navigation device, a sensor, a camera, a video camera, a three-dimensional camera, a global positioning system (GPS) device, a motion sensor, a radar device, a temperature sensor, a light sensor, a thermal imaging device, an infrared camera, an audio sensor, an ultrasound imaging device, a light detection and ranging (LIDAR) sensor, sound navigation and ranging (SONAR) device, a microwave sensor, a chemical sensor, a radiation sensor, an electromagnetic field sensor, a pressure sensor, a spectrum analyzer, a scent sensor, a moisture sensor, a biohazard sensor, a gyroscope, an altimeter, a microscope, magnetometer, a device capable is seeing through or inside of objects, or any other suitable instruments. A data source 116 can be any device that can communicate with computing device 102 and that can provide information to computing device 102 or receive information provided by computing device 102. It is to be appreciated that computing device 102, sensor 114, and/or data source 116 can be equipped with communication components (not shown) that enable communication between computing device 102, sensor 114, and/or data source 116 over one or more networks 112.

The various devices (e.g., computing device 102, sensor 114, and/or data source 116) and components (e.g., plan projector component 104, memory 108, processor 106 and/or other components) of system 100 can be connected either directly or via one or more networks 112. Such networks 112 can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

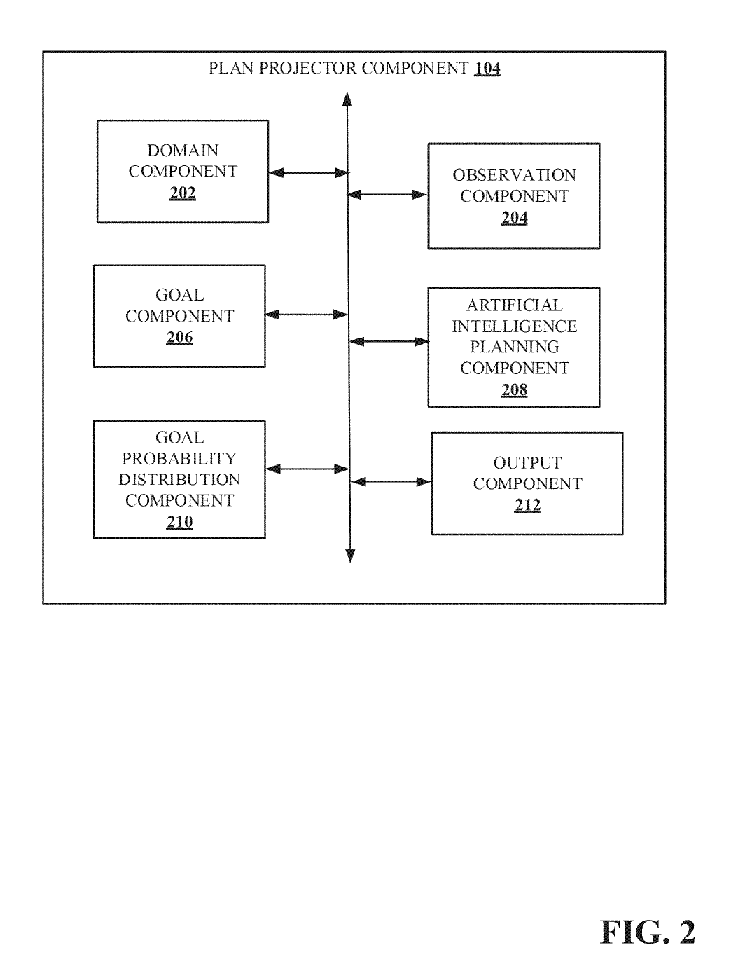

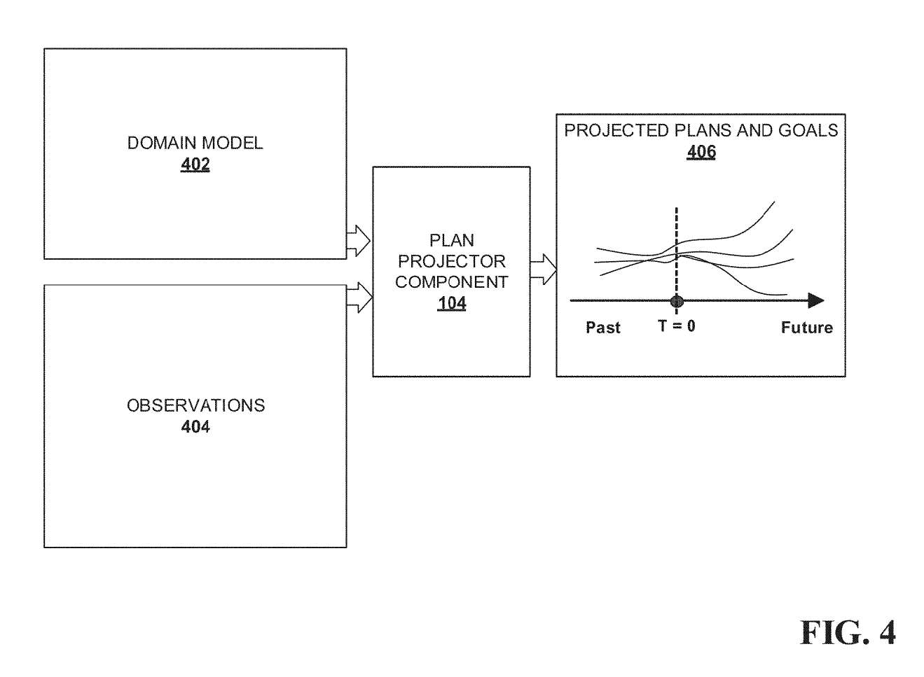

FIG. 2 illustrates a block diagram of an example, non-limiting plan projector component 104 in accordance with one or more embodiments described herein. FIG. 4 illustrates a block diagram of a plan projector component 104 that obtains a domain model 402 and observations 404 and determines projected plans and goals 406 using the domain model 402 and observations 404. Repetitive description of like elements employed in one or more embodiments described herein is omitted for sake of brevity.

Referring to FIG. 2, in one or more embodiments, the plan projector component 104 can automatically recognize one or more goals of one or more agents operating in a domain given a domain model and observations associated with the domain. Plan projector component 104 can include domain component 202 that can automatically obtain and/or generate a model (e.g., domain model) of a domain. In a non-limiting example, a domain model can describe characteristics of the domain, actions that can be performed in the domain which describes the transitions between states, a set of fluents, and the description of the initial states. In a non-limiting example, domain component 202 can obtain a domain model as input provided by a domain expert (e.g., a user who has expertise in the domain), such as in a non-limiting example expressed in a Planning Domain Description Language (PDDL). In another non-limiting example, domain component can obtain a domain model from a data source 116. While it is generally assumed that a planning domain is given as an input, that may not be possible because a domain expert often has no AI planning background and is not able to encode the knowledge in a planning language. Instead, the domain experts might be able to capture the knowledge in variety of tools available and known to them. For example, the domain experts may be able to easily encode the domain knowledge in a knowledge engineering tool, a non-limiting example of which is Mind Maps.

Domain component 202 can automatically translate the available domain knowledge captured in the knowledge engineering tool into a domain model (e.g., planning domain). The domain knowledge in a particular domain can be represented by one or more graphical maps (e.g., Mind Maps). The graphical map can be created in a knowledge engineering tool which produces an XML representation of the graphical map which can serve as an input to domain component 202. Domain component 202 can then translate the graphical map into an AI planning problem automatically. To do so, domain component 202 can develop a PDDL domain file with a fixed set of actions for all the given graphical maps, and automatically generate the grounding of these abstract actions in the PDDL problem file. The PDDL domain file can include high-level actions that represent the change in the transitions between two states (e.g., concepts). The PDDL problem file then provides the grounding of the actions, as indicated by the edges between two states. The resulting AI planning problem has a large number of predicates and a small fixed set of actions.

In another example, domain component 202 can automatically generate a questionnaire in order to obtain additional domain knowledge, such as weights of edges in a graphical map (e.g., Mind Map) from the domain expert. For example, the answers to the questionnaire provide additional information on the weights of the edges between the two states. In a non-limiting example, the weights can be categorized into three levels, low, medium, and high, and available for the domain expert to select as a drop-down option. The likelihood and impact levels are then encoded by domain component 202 as a cost of the high-level transition action in the planning domain, assigning a higher cost/penalty for the “low” option, a medium cost for the “medium” option, and a lower cost for the “high” option. While three levels, low, medium, and high, are depicted in this non-limiting example, it is to be appreciated that any suitable categorization can be employed by domain component 202.

In a further example, domain component 202 can automatically extract information regarding a domain from data sources 116, non-limiting examples of which can include articles, textbooks, Internet, search engines, data libraries, knowledge bases, or any other suitable source from which domain knowledge can be obtained.

Plan projector component 104 can also include observation component 204 that can automatically obtain and/or generate observations and/or fluents related to a domain and/or one or more agents operating in the domain. In a non-limiting example, observation component 204 can obtain a partially ordered sequence of observations, where at least one or more observations is a fluent condition that changes over time and any remaining observations in the sequence are action conditions. Observation component 204 can translate the action conditions into fluents.

The term “fluents” can refer to fluent conditions and/or other conditions that change over time. Fluent conditions can be conditions that change over time, and can include a variety of conditions associated with the domain. These fluent conditions can include, in non-limiting examples, degradation of an object, traffic within a loading dock, weather conditions over a defined geography, and other suitable conditions. Other fluent conditions and/or conditions that change over time are also contemplated, and the examples provided herein are not to be construed as limiting in any manner.

Definition 1 A planning problem with action costs is a tuple P=(F, A, I, G), where F is a finite set of fluent symbols, A is a set of actions with preconditions, Pre(a), add effects, Add(a), delete effects, Del(a), and non-negative action costs, Cost(a), I⊆F defines the initial state, and G⊆F defines the goal state.

A state, s, is a set of fluents with known truth value. An action a is executable in a state s if Pre(a)⊆s. The successor state is defined as δ(a, s)=((s\ Del(a))∪Add(a)) for the executable actions. The sequence of actions π=[a₁, . . . , aₙ] is executable in s if the state s′=δ(aₙ, δ(aₙ₋₁, . . . , δ(a₋₁, s))) is defined, where n is an integer. Moreover, π is the solution to the planning problem P if it is executable from the initial state and G⊆δ(aₙ, δ(aₙ₋₁, . . . , δ(a₋₁, I))). Furthermore, π is said to be optimal if it has minimal cost, or there exists no other plan that has a better cost than this plan. A planning problem P can have more than one optimal plan. Also, note that the tuple (F; A; I) is often referred to as the planning domain.

Definition 2 A plan recognition problem is a tuple R=(P′=(F, A, I), O, ξ, PROB), where P′ is the planning domain as defined above, O=[o₁, . . . , oₘ], where oᵢ∈F, i∈[1, m] is the sequence of observations, and ξ is the set of possible goals G, G⊆F, and PROB is the goal priors, where i is an index and m is an integer.

An observation O can generally be expressed as an Linear Temporal Logic (LTL) formula or Past LTL formula. In other words, one or more observations can in general be a logical expression over the set of fluents and appear as a precondition of an action. While it is possible to address this general type of observations, in this invention observations are at least partially sequenced, or are totally ordered, and such that each observation is an observable fluent. Observations over fluents are more general and flexible than observations over actions, because often in practice, actions are not directly observable, and instead some of the effects of the actions can be observed, for example, through sensors. These observations can be ambiguous since they can be part of the effect of more than one action and can hold true in the state until some other action removes them. However, the present invention also deals with observations over actions by assigning a unique fluent per action that is added only by that action. This is how the present invention is able to directly compare with the prior work which focused on observations over actions.

Noisy observations are defined as those that have not been added by the effect of any actions of a plan for a particular goal, while missing observations are those that have been added but were not observed (e.g., are not part of the observation sequence). To address noisy observations obtained by observation component 204, the definition of satisfaction of an observation sequence by an action sequence is modified to allow for observations to be left unexplained. Given an execution trace and an action sequence, an observation sequence is said to be satisfied by an action sequence and its execution trace if there is a non-decreasing function that maps the observation indices into the state indices as either explained or discarded

Definition 3 Let σ=s₀s₁s₂ . . . sₙ₊₁ be an execution trace of an action sequence π=[a₁, . . . , aₙ] from the initial state, where δ(aₙ, sᵢ)=sᵢ₊₁ is defined, for any i∈[0, n]. Given a planning domain P′, an observation sequence O=[o₁, . . . , oₘ], is satisfied by an action sequence π=[a₁, . . . , aₙ] from P′, and its execution trace σ if there is a non-decreasing function ƒ that maps the observation indices j=1, . . . , m into the state indices i=1, . . . , n+1, such that for all 0≤j≤m, either:

oⱼ∈s_{f(j)}, or Case 1 (explained):

oⱼ∉s_{f(j)} Case 2 (discarded):

The above definition deals with both complying with the observation order through the mapping of the non-decreasing function as well as the case where the observation is noisy and can need to be discarded in some instances. In one extreme, all observations will be explained by the sequence of states, and in the other extreme, all observations are discarded as it can be possible, but very unlikely, that the execution trace of the action sequence does not explain any of the observations because the observations do not appear as part of the effects of any of the actions. Also, note that there can be many such non-decreasing functions and that the definition holds as long as at least one such mapping exists. Moreover, note that the function does not define a one-to-one mapping as there can exist a state that is mapped to multiple observations (e.g., the state explains multiple observations). This can be either because the action produces multiple effects, each of which can be separate observations, or that the previous observation (or the fluent) was never removed from the state, and hence, it can be observed in a later state.

Observation component 204 can obtain and/or generate observations and/or fluents based on data received from one or more sensors 114 and/or one or more data sources 116. It is to be appreciated that data obtained by observation component 204 can be real-time data and/or historical data. A sensor 114 can capture observations in the domain. For example, a camera can record activity in the domain. A data source 116 can store observations from the domain. For example, a security log can record entries and exits through a door. In another example, newspaper articles can describe observations in the domain.

Plan projector component 104 can also include goal component 206 that can obtain full and/or partial sets of possible goals related to a domain. For example, goal component 206 can obtain the full and/or partial sets of possible goals from a data source 116. In another example, goal component 206 can present a user interface to allow a user to enter the full and/or partial sets of possible goals. If a partial set of possible goals is obtained, goal component 206 can further obtain a future time horizon for which the goal recognition should occur, and also can obtain a threshold (e.g., a similarity threshold) for clustering of plans. The future time horizon and threshold for clustering can be employed with the domain model, observations, and partial set of possible goals to allow plan projector component 104 to recognize possible goals that are not in the partial set of possible goals.

Plan projector component 104 can also include artificial intelligence planning component 208 can employ an artificial intelligence planner to determine a solution to the goal recognition problem by transforming the goal recognition problem (e.g., a plan recognition problem associated with a set of possible goals) into an artificial intelligence planning problem. The solution determined by artificial intelligence planning component 208 can contain both a set of plans and a set of goals.

Artificial intelligence planning component 208 can include a transformation component 302 that can transform the goal recognition problem into an artificial intelligence planning problem. This transformation allows use of AI planning, in particular, the use of planners capable of finding a plan set, to compute a set of plans and a set of goals for a goal recognition problem.

There are several ways that transformation component 302 can compile away the observations depending on the nature of observations. For example, if observations are actions then transformation component 302 can take the approach as described below. Observations can also be compiled away by transformation component 302 using an “advance” action that ensures the observation order is preserved.

As mentioned earlier, the observations are over the set fluents, so there is no assumption that the action is observable directly. There are however, some fluents that appear as part of a result or an effect of some actions that are observable. It is possible that not all observations are reliable meaning that the resulting artificial intelligence planning problem should take into account the case that some observation is out of context or is noisy and hence can be discarded. Also, observations can be ambiguous, so it can be possible for the same observable fluent to appear as part of the effects of more than one planning action. Ultimately, a solution to the artificial intelligence planning problem that is shorter and explains as much observations as possible have a lower cost. So, each action will be associated with a cost and a plan with the lower cost is considered the most likely solution.

To create the new artificial intelligence planning problem, the existing actions can be augmented by transformation component 302 with a set of “discard” and “explain” actions for each observation oi in the observation sequence O. These actions ensure that the observation was considered while in some cases it will need to be discarded. In particular, the noisy observations can be skipped using the “discard” actions. The order of the observations is preserved by the so called “considered” predicates, that is set to true if the observation is either explained to discarded. So consideredₒᵢ, indicates that observation I has been considered. Observation 0, or Oo is added as dummy initial observation and considered_{Oo} is set to true initially. Furthermore, at least one of the goals G∈ξ is satisfied by the computed plans. This is done by creating an action by transformation component for each G∈ξ with a special add predicate referred to as “done”. The goal state will be updated to include this “done” predicate. This ensures that the search is restricted and only plans that meet at least one of the given goals are considered. In Definition 5 below, h is an action, and g is a goal (e.g. goal description).

Definition 5 For a plan recognition problem R=(F, A, I, O, ξ, PROB), a new planning problem is created with action costs P=(F′, A′, I′, G′) such that:

F′=F∪{done,considered_{Oo}∪{considered_{Oi}|oᵢ∈O},

I′=I∪{considered_{Oo}},

G′={done,considered_{Om}}, where oₘ is the last observation,

A′=A_{orig}∪A_{goal}∪A_{discard}∪Aₑₓₚₗₐᵢₙ, where,

−A_{orig}={hₐ|a∈A,Cost(hₐ)=Cost(a)+b₁×|{oᵢ|oᵢ∈Add(a)∧oᵢ∈T∧oᵢ∉O}, where T⊆F is the set of observable fluents

−A_{goal}={h_{g}|g∈ξ,Cost(h_{g})=0,Pre(h_{g})={g},Add(h_{g})={done}},

−A_{discard}={hₒ_{ᵢ}|oᵢ∈O,Cost(hₒ_{ᵢ})=b₂,Pre(hₒ_{ᵢ})={¬oᵢ,considered_{Oi-1}},ADD(hₒ_{ᵢ})={considered_{Oi}},Del(hₒ_{ᵢ})={considered_{Oi-1}},

Aₑₓₚₗₐᵢₙ={hₒ_{ᵢ}|oᵢ∈O,Cost(hₒ_{ᵢ})=0,Pre(hₒ_{ᵢ})={oᵢ,considered_{Oi-1}},ADD(hₒ_{ᵢ})={considered_{Oi}},Del(hₒ_{ᵢ}){considered_{Oi-1}},

Note, the cost of the plans for P′ now encodes a penalty for the missing observations and unexplained observation. The original cost of an action is updated to account for the possible missing observations. The two actions explain and discard have a cost that motivates finding plans that explain as many observations as possible. Also, note that the above definition deals with any observation oᵢ that can appear as part of a precondition of an action, and does not necessary have to be a single fluent.

Theorem 1 Given a plan recognition problem R=(F, A, I, O, ξ, PROB), and the corresponding new planning problem P′=(F′, A′, I′, G′) as defined in Definition 5, for all G∈ξ, if π is a plan for R, there exists a plan π′ for P′ such that π can be constructed straightforwardly from by removing the extra actions (e.g., discard, explain, and goal actions), and mover importantly, V_{O,G}(π)=COST(π′). On the other hand, if there is a plan π′ for P′, then there exists a plan π for P that can be constructed from by removing the extra actions such that V_{O,G}(π)=COST(π′).

Proof sketch: (⇒) Proof is based on the fact that the extra actions do not change any of the observable fluents while preserving the ordering amongst the observations. Moreover, cost of the plans now map to V_{O,G}(π), hence, the posterior probabilities, P(G|O) and P(π|O), can be computed using the cost of the plans in the transformed planning problem. Note that these probabilities will be different based on which method is used to generate a sample set of plans.

To address the first question, we provide and approximation that takes into account not only the original cost of the actions but also the number of missing and noisy observations. Hence, we define a weighted factor, V_{O,G}(π), that combines all our three objectives as follows:

V_{O,G}(π)=COST(π)+b₁×M_{O,G}(π)b₂×N_{O,G}(π)

where π is a plan that meets the goal G and satisfies O. M_{O,G} (π) is the number of missing observations in O, N_{O,G}(π) is the number of noisy observations in O, b₁ and b₂ are the corresponding coefficients assigning weights to the different objectives.

Transformation component 302 can also address the scenario where an agent can be pursing multiple possible goals. For example, it is possible that if given possible goals G1, and possible goals G2, for example, all actions associated with achieving G1 is executed before executing actions for achieving G2, which we call “sequentially independent goals”. In another example, there might be an added benefit by having some shared actions between the possible goals, so that the total length of the plan for G1+G2 is reduced. We call this case the “sequentially dependent goals”. It is important to consider these two cases, because separating the two cases can improve the efficiency of finding the set of plans and ultimately improve the goal recognition accuracy.

In the case of “sequentially dependent goals”, transformation component 302 can use a special predicate called “done” not just for each possible goal, but also for a combination of possible goals. So for example, if there are 3 possible goals G1, G2, and G3, and it is possible to achieve G1 and G2, or G2 and G3, then we need to update the planning domain to include the “done” predicate for when both G2 and G3 are achieved, or when both G1 and G2 are achieved. Note this case still assumes that the set of possible goals is given, but in this case we are not assuming that only one possible goal can be pursed at the time. For example, if there are n possible goals, Transformation component 302 can consider all 2ⁿ cases, however, that set can be reduced by considering only a subset of those possible cases. Transformation component 302 can compute a plan that meets any of the possible goals individually and/or a subset of the possible goals.

In the case of “sequentially independent goals”, that is not possible. The case of “sequentially independent goals” means that even though there are multiple possible goals, each possible goal can be done in sequence, and there no shared action between them. In this case, then we propose that you need to create multiple planning problems one for each possible goal, and run the planner for each of these planning problems separately with that specific possible goal. This can be thought of as separating the bigger problem into multiple smaller problems and then combining the final result in a post processing step. Thus, transformation component 302 can use multiple different special predicates, one for each combination of goals and create several planning problems to solve. Then artificial intelligence planning component 208 can combine the sets of all high-quality plans determined for all of the planning problems in order to compute the probability distributions over the goals.

To create the new planning problem, the existing actions are augmented with a set of “discard” and “explain” actions for each observation of in the observation sequence O. These actions ensure that the observation was considered while in some cases it will need to be discarded. The order of the observations is preserved by “considered” predicates. Furthermore, at least one of the goals G∈ξ is satisfied by the computed plans. This is done by creating an action for each G∈ξ with a special add predicate referred to as “done”. The goal state will be updated to include this “done” predicate. This ensures that the search is restricted and only plans that meet at least one of the given goals are considered.

Transformation component 302 can also perform the transformation of the goal recognition problem to account for past observations, as well as projection to the future.

Definition 6 A Future State Projection problem is defined as a tuple FSP=(F, A, I, O, T, K), where (F, A, I) is the planning domain as defined above, O=[oᵢ, . . . , oₘ], where oᵢ∈F, i∈[1, m] is the sequence of observations, T is the number of time steps into the future, K is the number of trajectories to produce.

Note, as in the case of plan recognition problem, each observation is over a fluent rather than an action, as it is often the case that the actions are not directly observable, but their effects through the change in the state of the world are observable. Also, note that the problem definition does not include a full set of possible goals, instead, T, a number of time steps into the future, is given. In other words, T is the number of actions that must be executed after the last observation is explained or discarded; henceforth, referred to as the future actions. Hence, a trajectory that considers T steps into the future, considers T many future actions.

Definition 7 Given a FSP problem (F, A, I, O, T, K), a trajectory is a tuple (s, π), where (1): r=[a₀, . . . , aₙ; aₙ+1, . . . , a_{n+T}] is an action sequence that is executable from the initial state I and results in state s=δ(aₙ₊ₙ′, . . . , δ (a₀, I)), and (2): the observation sequence is satisfied by the action sequence [a₀, . . . , aₙ]. A solution to the FSP problem is a collection of K trajectories.

The trajectory includes the final state s together with its “explanation”, π. Each action sequence π, comprises of actions that explain or discard the observations (e.g., [a₀, . . . , aₙ]) and T many future actions reachable in T steps after the last observation, oₘ is either explained or discarded, according to the domain description. While there are many trajectories for a given Future State Projection (FSP) problem, a trajectory with an action sequence that has the lowest cost, lowest number of missing, and lowest number of noisy observations is more probable. Note that this is the same objective function defined for the plan recognition problem that is used to estimate the posterior probabilities. This objective function also maps to the cost of the plan in the transformed planning problem.

To address the problem where the set of inputs does not include the full set of possible goals G, we are given the time step T. The time horizon together with the observations now comprise the goal for the planning problem.

To address generation of future T many actions, transformation component 302 adds a special observable fluent FO to F, and also to the add effect of all the original actions (e.g., for all a∈A, FO∈ADD(a)). This means that transformation component 302 can explicitly modify the sequence of observations to add T many observations of type FO. transformation component 302 can also ensure the order of observations is preserved, that is, first the past observations are explained or discarded, and then T many future observations are explained. To do so, transformation component 302 can employ another special predicate lₒᵢ, that is set to true if the observation is either explained to discarded. Also, transformation component 302 can add to the goal state, the special predicate associated with the final observation. Finally, transformation component 302 can update the set of actions to include a set of actions that explain or discard the “past” observations, and explain the “future” observations. To explain the “past” observation, the fluent associated with that observation must be true in the state, and to explain the “future” observation, the special fluent FO must be true in the state, so must have been added by an action. Also for all the three types of actions, lₒᵢ₋₁ must be true in the state, and deleted when lₒᵢ is added to the effect. This ensures that the order of observations in preserved. Note, transformation component 302 can set the cost of the discard action higher than the explain action to encourage explaining as many observations as possible.

Artificial intelligence planning component 208 can include a plan component 304 that can determine a solution to the artificial intelligence planning problem using any suitable artificial intelligence planner to determine a set of plans and a set of goals.

In a first example, plan component 304 can employ a top-k planner. The top-k planning problem is a tuple T=(P, k), where P is the planning problem with action costs as defined in Definition 1, and k is the number of plans to find. Let n be the number of valid plans for the planning problem P. The solution to the top-k planning problem T is a set of plans Π={π₁, . . . , πₘ}, such that:

if k≤n, then m=k, otherwise m=n,

each π∈Π is a plan for the planning problem P, and

there does not exists a plan π′ for P, π′, ∉Π such that cost(πᵢ′)<cost(π) for all πᵢ∈Π

Note that the solution to the top-k planning problem, Π can contain just one optimal plan in some cases (if k=1), all optimal plans (if k equals the number of optimal plans for P), or all optimal plans and some suboptimal plans (if k is large enough). If Π≠0, Π contains at least one optimal plan and when k>n, Π contains all n valid plans.

Proposition 1 Given a number k, a plan recognition problem R, and the corresponding new planning problem P as defined by Definition 5, if Π is a solution to the top-k planning problem (P; k), then (Π, [symbol] ) is a solution to the plan recognition problem R, where Π′ is constructed from H such that each plan is stripped from its extra actions, and [symbol] is a set of goals achieved by Π.

Note that while the set of plans for the solution of the plan recognition problem is not required to have high quality or be low cost, use of the top-k planning approach is guaranteed to find such a set. In turn, if that the assumption with respect to the inverse relationship between costs and probability of an agent pursing a goal holds, then the use of a top-k planning technique would provide a solution that has the highest posteriors probabilities for both goals and plans. However, cost-optimal planning is a difficult problem and is even more difficult to guarantee finding the top-k plans. Therefore, as seen below in the described experiments, the top-k planning approach does not always yield the best performance which is mainly due to the large search space and that the planner used ran out of time. However, better performance is expected when the search space is smaller. This is often the case in the real-word applications of a plan recognition problem, and/or use a more efficient top-k planner.

There are several techniques to computing the top-k plans. In this example, the top-k planning planner called TK* is used that is based on the use of a k shortest paths technique called the K* algorithm as it is shown that this planner outperforms other planners or techniques for top-k planning K shortest paths problem is an extension of the shortest path problem where in addition of finding one shortest path, a set of paths is found, representing the k shortest paths. One or more embodiments of the K* algorithm does not require the complete graph of states and actions to be available in memory. Informally, k* search switches between A* and Dijkstra searches to evaluate and find the top-k plans. Its main idea is to keep track of what is called a “sidetrack” edges which indicate how far a partial plan is from the optimal plan. TK*, applies K* to search in state space, with dynamic grounding of actions, similar to how a planner can use A* search. Soundness and completeness of TK* follows directly from the soundness and completeness of the K* algorithm.

In a second example, plan component 304 can employ a diverse planner. In diverse planning the objective is find a set of plans m that are at least d distance away from each other. The distance between plans can be computed by plan component 304 by considering the plans as a set of actions, a sequence of states, or casual links and defining a distance metric that compares two plans and computes a number between 0 (e.g., the two plans are different) and 1 (e.g., the plans are similar). There are several evaluation metrics defined such as stability, uniqueness, and parsimony that can be used by plan component 304 to evaluate the diverse planners.

In this example, diverse planning problem can be defined as a tuple D=(m; d), where m is the number of plans to find, and d is the minimum distance between the plans. The solution to the diverse planning problem D is a set of plans H, such that |Π|=m and for each pair of plans π∈Π, π′∈Π, min δ(π, π′)≥d, where δ(π, π′) measures the distance between plans.

The following proposition is similar proposition to Proposition 1, in which the top-k planning is replaced with diverse planning. The purpose of this proposition is to define a clear correspondence between diverse planning and a plan recognition problem, which is key to allowing us use diverse planning for the purpose of a plan recognition problem.

Proposition 2 Given a diverse planning problem D=(m, d) a plan recognition problem R, and the corresponding new planning problem P as defined by Definition 5, if Π is a solution to the diverse planning problem D, then Π′ is a solution to the plan recognition problem R, where Π′ is constructed from Π such that each plan is stripped from its extra actions, and is from its extra actions, and [symbol] is a set of goals achieved by Π.

There are several techniques to computing the diverse plans and there are several diverse planners that exist. In this example, plan component 304 can use a diverse planner, LPG-d, for two example reasons: (1) LPG-d is readily available and capable of being ran, and (2) LPG-d shows relatively better performance compared to the other diverse planners. LPG-d is an extension of the planner LPG which is a local search based planner. Experimentation showed that the following three exemplary settings of LPG-d can be used by plan component 304 with good performance, (10; 0:75), (50; 0:5), and (100; 0:75), although any suitable settings can be employed.

Artificial intelligence planning component 208 can include a clustering component 306 that can cluster the set of plans to determine plans that in pursuit of the set of possible goals that are provided (e.g., full set of possible goals or partial set of possible goals, as well as, determine other possible goals. For example, clustering component 306 can employ any suitable clustering technique to cluster the determined plans into clusters.

Non-limiting examples of clustering models that can be employed by clustering component 306 can include density peak searching clustering, k-means clustering, k-medoids clustering, connectivity-based clustering, centroid-based clustering, distribution-based clustering, density-based clustering, fuzzy clustering, biclustering, or any other suitable clustering model.

In an example, where no goals are given or a partial set of goals are given, clustering component 306 can employ a threshold (e.g., similarity threshold) to cluster the determined plans. Each cluster can have a representative plan that can be employed as a representative possible goal for the cluster. For example, if a partial set of goals are given, then the given goals can be selected by clustering component 306 as the representative goals for the respective clusters in which the corresponding plans reside. The clusters for which a given goals is not employed as a representative possible goal, clustering component 306 can employ the representative plan a representative possible goal for the cluster. In a non-limiting example, clustering component 306 generated 20 clusters, that means 20 possible goals could have been given to the system. If only 4 possible goals were provided as input, clustering component 306 generated 20 clusters, this can mean 16 new clusters representing 16 possible goals were discovered which were not provided as input of possible goals.

Plan projector component 104 can also include a goal probability distribution component 210 that can determine a probability distribution of all possible goals given the set of plans and/or their clusters.

Definition 4 Given a plan recognition problem R=(P′;O;ξ), where P′, O, and ξ are defined as above, a solution to R is a tuple (Π, [symbol] ) where H is a set of plans, and [symbol] is a set of goals such that:
1. for each action sequence π=[a₁, . . . , aₙ], π∈Π, the observation sequence O is satisfied by the execution trace of π, σ=s₀s₁s₂ . . . sₙ₊₁, and there exists at least one goal G∈ξ such that G∈ξ sₙ₊₁, and
2. for each G∈ [symbol] , G∈ξ and there exists a plan π∈Π, such that G⊆sₙ₊₁, where sₙ₊₁ is the last state in the execution trace of π.

Assuming an implicit relationship between the cost of each plan and the probability that the agent is likely to choose this plan, and subsequently the goal of this plan, posterior probabilities P(G|O) and P(π|G) can be defined by goal probability distribution component 210. The assumption in the relationship between costs and probabilities is different from that of prior work, this is illustrated in an example with the cooking room domain. In the cooking room domain there are two types of actions: low-level actions such as “take bread” or “use toaster”, and high-level actions such as “boil water” with effect “boiled water” which can be used as a precondition for “make tea” or “make coffee”. For breakfast, you need to have cereal, buttered toast, and either coffee or tea. For dinner, you can have a salad (which does not require bread) or a cheese sandwich or both. The effect of the low level actions are observable. This domain has many ambiguous observations such as “take bread” because without further observations, these do not rule out the goals (e.g., the agent can be pursing any of the goals). However, given only the observation “take bread”, since the plans for making dinner are shorter than the plans for making breakfast, the approach in this patent is to assign a high probability to the dinner goal and a low probability to the breakfast goal. However, since the agent can have salad as oppose to a sandwich, which is a shorter plan, the prior work assigns a low probability to the dinner goal and a high probability to the breakfast goal even though, there are a number of other observations from making breakfast that is are not given in the observation sequence.

It is to be appreciated that goal probability distribution component 210 can employ any suitable algorithm for determining a probability distribution of all possible goals given the set of plans and/or their clusters.

Plan projector component 104 can also include an output component 212 that can generate one or more data structures, one or more reports, and or displays with respect to the determined sets of plans and/or set of recognized goals. For example, output component 212 can also provide a user interface that presents the resulting clusters and allows user interaction and navigation with the clusters. For example, clustering component 306 select and display a representative example of a plan for each cluster. A user can select a cluster and drill down into the cluster to see plans in the cluster, as well as details of the plans. In another example, output component 212 can present a display the depicts one or more recognized goals with their associated probabilities. It is to be appreciated that output component 212 that can generate the one or more data structures, one or more reports, and or displays with respect to the determined sets of plans and/or set of recognized goals in any suitable format.

Output component 212 can also communicate information related to one or more recognized goals to an intelligent software assistant, an robotic device, an unmanned vehicles, or any other suitable automated assistant that initiates the intelligent software assistant, robotic device, unmanned vehicles, or other suitable automated assistant to initiate performing one or more actions to assist an agent in achieving the one or more recognized goals.

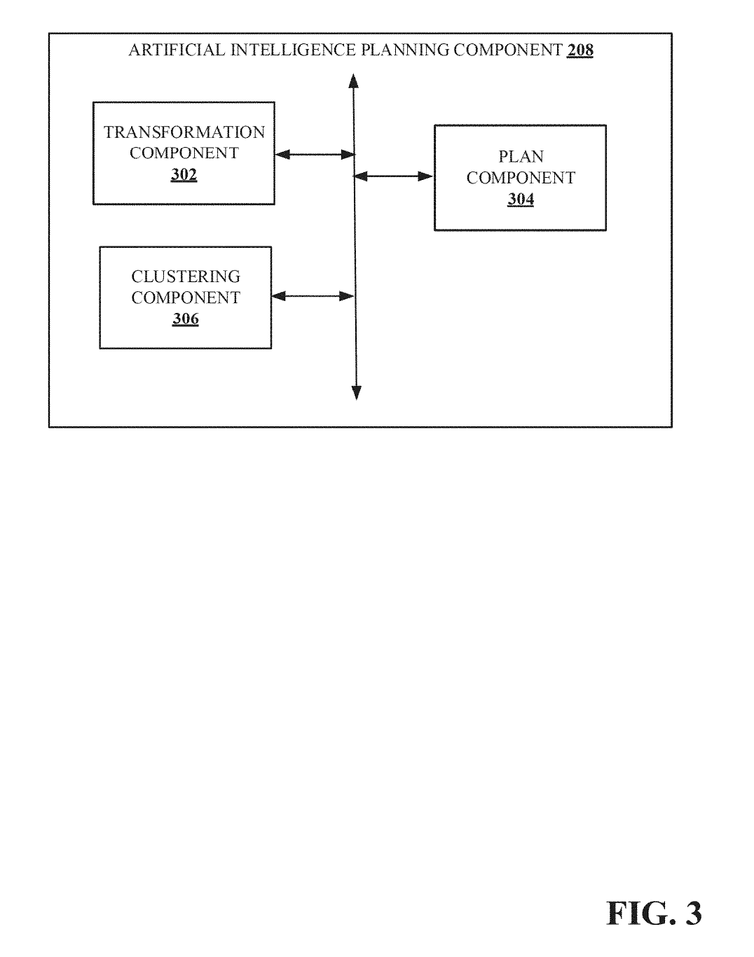

While FIGS. 1, 2, 3, and 4 depict separate components in computing device 102, it is to be appreciated that two or more components can be implemented in a common component. Further, it is to be appreciated that the design of the computing device 102 can include other component selections, component placements, etc., to facilitate automatically recognizing goals in accordance with one or more embodiments described herein. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

Further, some of the processes performed can be performed by specialized computers for carrying out defined tasks related to automatically recognizing goals. The subject computer processing systems, methods apparatuses and/or computer program products can be employed to solve new problems that arise through advancements in technology, computer networks, the Internet and the like. The subject computer processing systems, methods apparatuses and/or computer program products can provide technical improvements to systems automatically recognizing goals in a live environment by improving processing efficiency among processing components in these systems, reducing delay in processing performed by the processing components, and/or improving the accuracy in which the processing systems automatically recognize goals.

The embodiments of devices described herein can employ artificial intelligence (AI) to facilitate automating one or more features described herein. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determination.

A classifier can map an input attribute vector, z=(z1, z2, z3, z4, zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

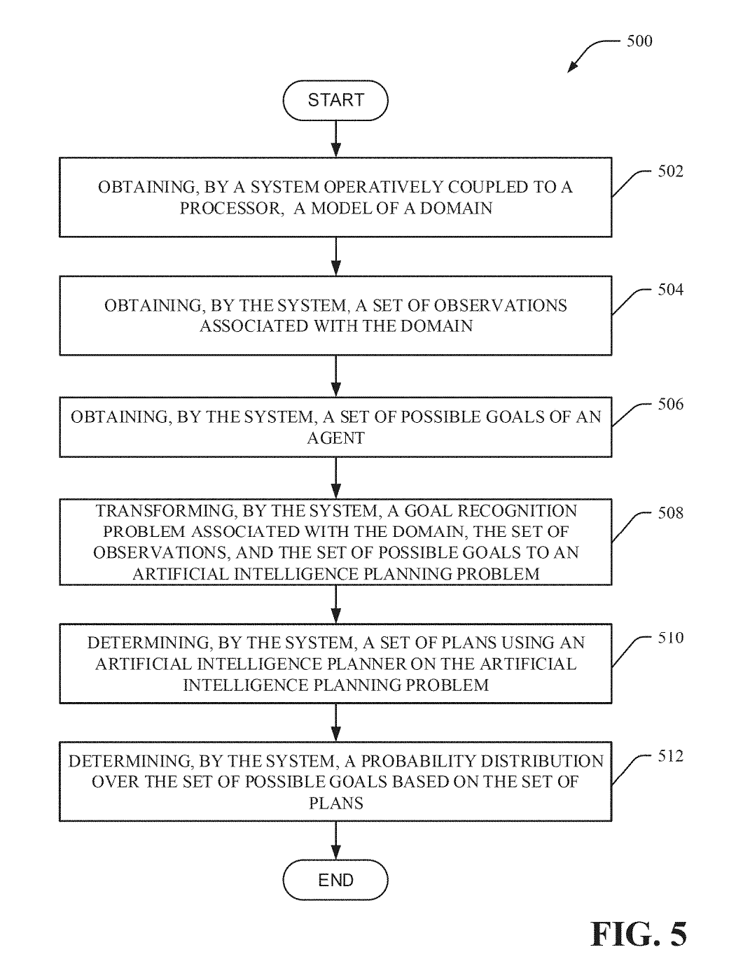

FIG. 5 illustrates a flow diagram of an example, non-limiting computer-implemented method 500 that facilitates automatically recognizing goals when a full set of possible goals are provided in accordance with one or more embodiments described herein. Repetitive description of like elements employed in other embodiments described herein is omitted for sake of brevity.

At 502, method 500 can comprise obtaining, by a system operatively coupled to a processor, a model of a domain (e.g., via a domain component 202, a plan projector component 104, and/or a computing device 102). At 504, method 500 can comprise obtaining, by the system, a set of observations associated with the domain (e.g., via an observation component 204, a plan projector component 104, and/or a computing device 102). At 506, method 500 can comprise obtaining, by the system, a set of possible goals of an agent (e.g., via a goal component 206, a plan projector component 104, and/or a computing device 102). At 508, method 500 can comprise transforming, by the system, a goal recognition problem associated with the domain, the set of observations, and the set of possible goals to an artificial intelligence planning problem (e.g., via transformation component 302, an artificial intelligence planning component 208, a plan projector component 104, and/or a computing device 102). At 510, method 500 can comprise determining, by the system, a set of plans using an artificial intelligence planner on the artificial intelligence planning problem (e.g., via a plan component 304, an artificial intelligence planning component 208, a plan projector component 104, and/or a computing device 102). At 512, method 500 can comprise determining, by the system, a probability distribution over the set of possible goals based on the set of plans (e.g., via a goal probability distribution component 210, a plan projector component 104, and/or a computing device 102).

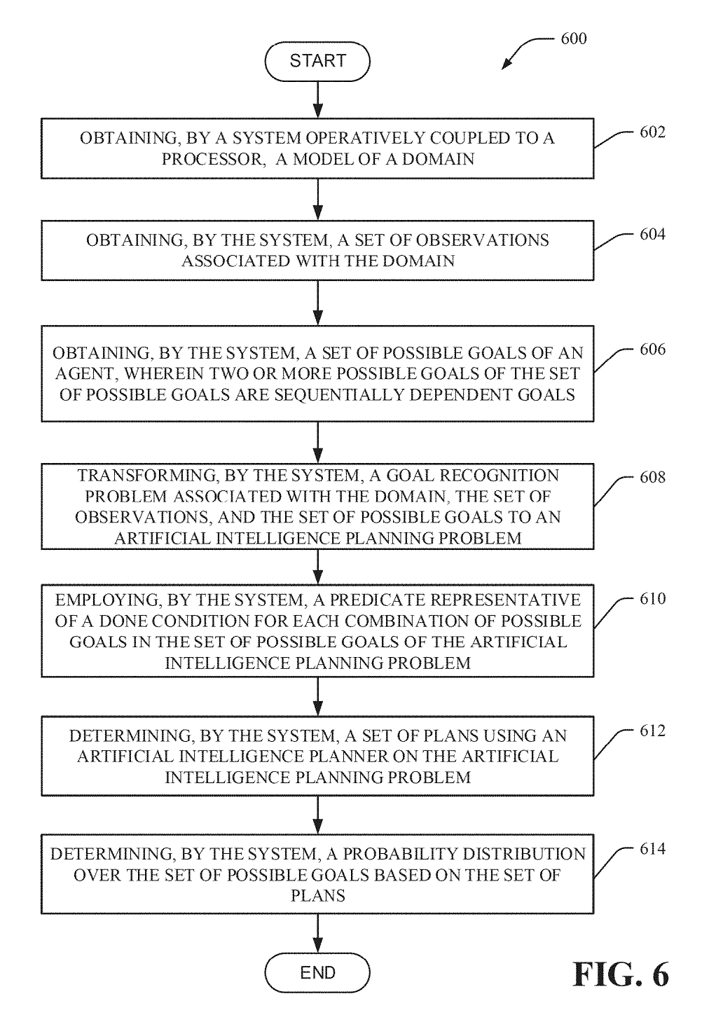

FIG. 6 illustrates a flow diagram of an example, non-limiting computer-implemented method 600 that facilitates automatically recognizing goals when a full set of possible goals are provided that can include sequentially dependent goals in accordance with one or more embodiments described herein. Repetitive description of like elements employed in other embodiments described herein is omitted for sake of brevity.

At 602, method 600 can comprise obtaining, by a system operatively coupled to a processor, a model of a domain (e.g., via a domain component 202, a plan projector component 104, and/or a computing device 102). At 604, method 600 can comprise obtaining, by the system, a set of observations associated with the domain (e.g., via an observation component 204, a plan projector component 104, and/or a computing device 102). At 606, method 600 can comprise obtaining, by the system, a set of possible goals of an agent, wherein two or more possible goals of the set of possible goals are sequentially dependent goals (e.g., via a goal component 206, a plan projector component 104, and/or a computing device 102). At 608, method 600 can comprise transforming, by the system, a goal recognition problem associated with the domain, the set of observations, and the set of possible goals to an artificial intelligence planning problem (e.g., via transformation component 302, an artificial intelligence planning component 208, a plan projector component 104, and/or a computing device 102). At 610, method 600 can comprise employing, by the system, a predicate representative of a done condition for each combination of possible goals in the set of possible goals of the artificial intelligence planning problem (e.g., via transformation component 302, an artificial intelligence planning component 208, a plan projector component 104, and/or a computing device 102). At 612, method 600 can comprise determining, by the system, a set of plans using an artificial intelligence planner on the artificial intelligence planning problem (e.g., via a plan component 304, an artificial intelligence planning component 208, a plan projector component 104, and/or a computing device 102). At 614, method 600 can comprise determining, by the system, a probability distribution over the set of possible goals based on the set of plans (e.g., via a goal probability distribution component 210, a plan projector component 104, and/or a computing device 102).

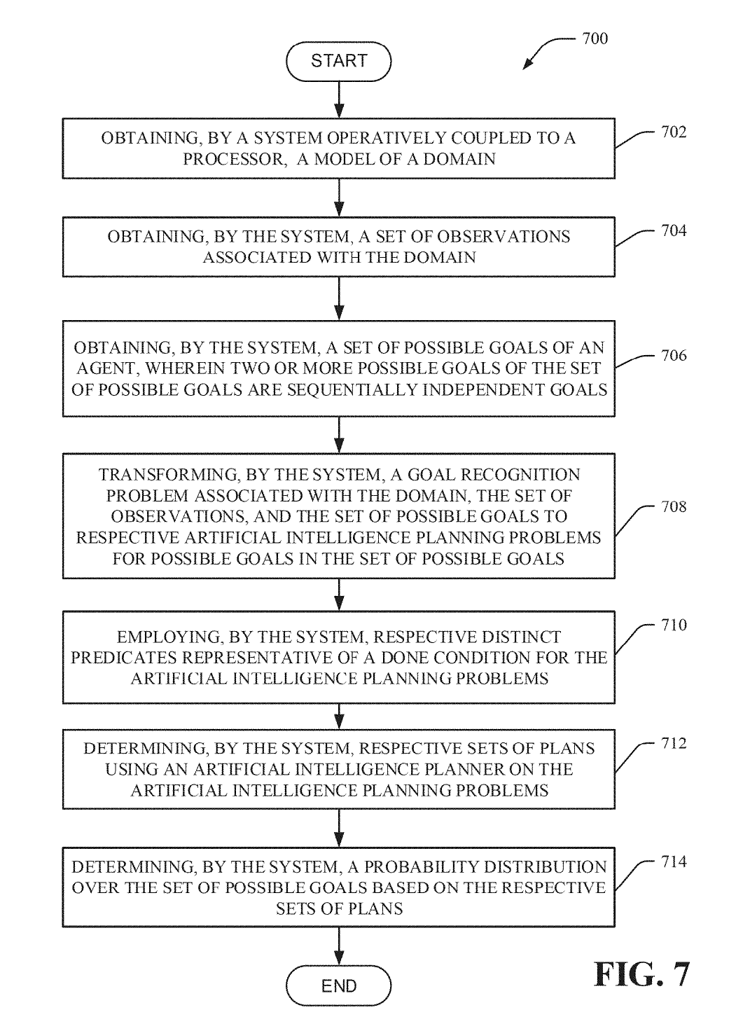

FIG. 7 illustrates a flow diagram of an example, non-limiting computer-implemented method 700 that facilitates automatically recognizing goals when a full set of possible goals are provided that can include sequentially independent goals in accordance with one or more embodiments described herein. Repetitive description of like elements employed in other embodiments described herein is omitted for sake of brevity.

At 702, method 700 can comprise obtaining, by a system operatively coupled to a processor, a model of a domain (e.g., via a domain component 202, a plan projector component 104, and/or a computing device 102). At 704, method 700 can comprise obtaining, by the system, a set of observations associated with the domain (e.g., via an observation component 204, a plan projector component 104, and/or a computing device 102). At 706, method 700 can comprise obtaining, by the system, a set of possible goals of an agent, wherein two or more possible goals of the set of possible goals are sequentially independent goals (e.g., via a goal component 206, a plan projector component 104, and/or a computing device 102). At 708, method 700 can comprise transforming, by the system, a goal recognition problem associated with the domain, the set of observations, and the set of possible goals to respective artificial intelligence planning problems for possible goals in the set of possible goals (e.g., via transformation component 302, an artificial intelligence planning component 208, a plan projector component 104, and/or a computing device 102). At 710, method 700 can comprise employing, by the system, respective distinct predicates representative of a done condition for the artificial intelligence planning problems (e.g., via transformation component 302, an artificial intelligence planning component 208, a plan projector component 104, and/or a computing device 102). At 712, method 700 can comprise determining, by the system, respective sets of plans using an artificial intelligence planner on the artificial intelligence planning problems (e.g., via a plan component 304, an artificial intelligence planning component 208, a plan projector component 104, and/or a computing device 102). At 714, method 700 can comprise determining, by the system, a probability distribution over the set of possible goals based on the respective sets of plans (e.g., via a goal probability distribution component 210, a plan projector component 104, and/or a computing device 102).

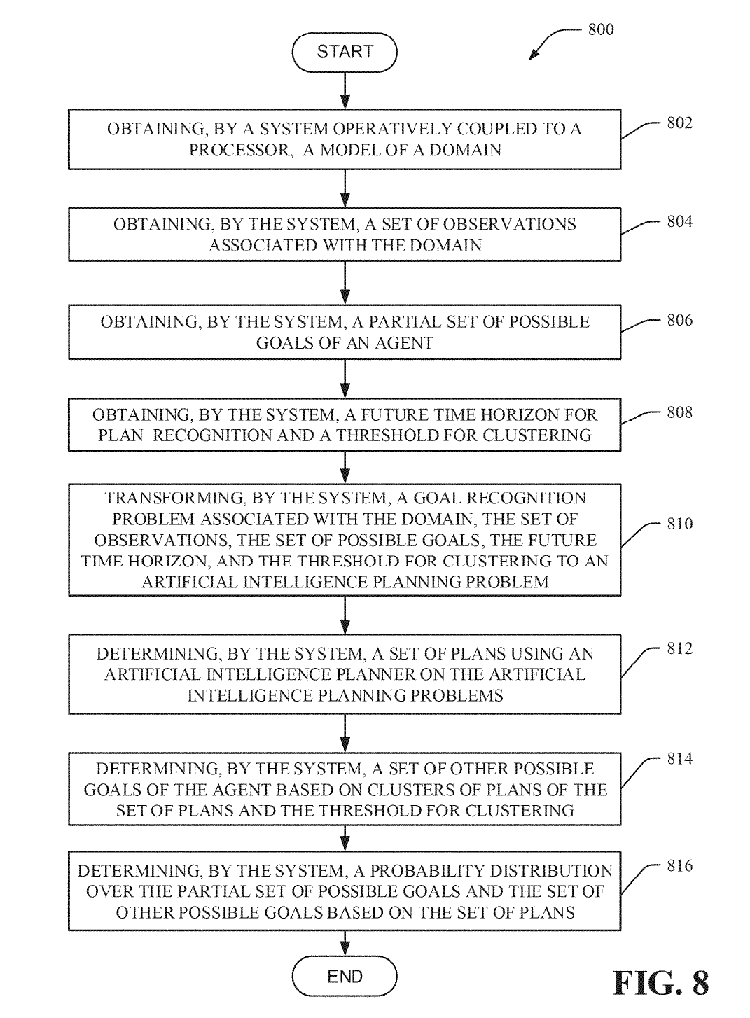

FIG. 8 illustrates a flow diagram of an example, non-limiting computer-implemented method 800 that facilitates automatically recognizing goals when a partial set of possible goals are provided in accordance with one or more embodiments described herein. Repetitive description of like elements employed in other embodiments described herein is omitted for sake of brevity.

At 802, method 800 can comprise obtaining, by a system operatively coupled to a processor, a model of a domain (e.g., via a domain component 202, a plan projector component 104, and/or a computing device 102). At 804, method 800 can comprise obtaining, by the system, a set of observations associated with the domain (e.g., via an observation component 204, a plan projector component 104, and/or a computing device 102). At 806, method 800 can comprise obtaining, by the system, a partial set of possible goals of an agent (e.g., via a goal component 206, a plan projector component 104, and/or a computing device 102). At 808, method 800 can comprise obtaining, by the system, a future time horizon for plan recognition and a threshold for clustering (e.g., via a goal component 206, a plan projector component 104, and/or a computing device 102). At 810, method 800 can comprise transforming, by the system, a goal recognition problem associated with the domain, the set of observations, the set of possible goals, the future time horizon, and the threshold for clustering to an artificial intelligence planning problem (e.g., via transformation component 302, an artificial intelligence planning component 208, a plan projector component 104, and/or a computing device 102). At 812, method 800 can comprise determining, by the system, respective sets of plans using an artificial intelligence planner on the artificial intelligence planning problems (e.g., via a plan component 304, an artificial intelligence planning component 208, a plan projector component 104, and/or a computing device 102). At 814, method 800 can comprise determining, by the system, a set of other possible goals of the agent based on clusters of plans of the set of plans and the threshold for clustering (e.g., via a plan component 304, a clustering component 306, an artificial intelligence planning component 208, a plan projector component 104, and/or a computing device 102). At 816, method 800 can comprise determining, by the system, a probability distribution over the partial set of possible goals and the set of other possible goals based on the set of plans (e.g., via a goal probability distribution component 210, a plan projector component 104, and/or a computing device 102).

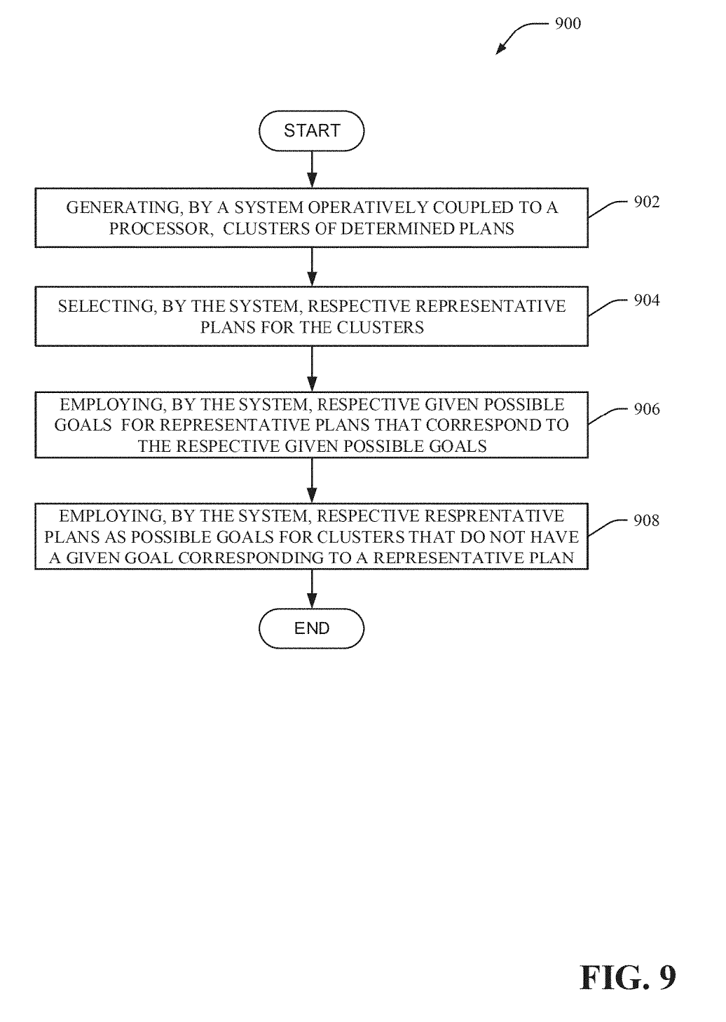

FIG. 9 illustrates a flow diagram of an example, non-limiting computer-implemented method 900 that facilitates automatically employing clustering for recognizing goals when a partial set of possible goals are provided in accordance with one or more embodiments described herein. Repetitive description of like elements employed in other embodiments described herein is omitted for sake of brevity.

At 902, method 900 can comprise generating, by a system operatively coupled to a processor, clusters of determined plans (e.g., via a clustering component 306, an artificial intelligence planning component 208, a plan projector component 104, and/or a computing device 102). At 904, method 900 can comprise selecting, by the system, respective representative plans for the clusters (e.g., via a clustering component 306, an artificial intelligence planning component 208, a plan projector component 104, and/or a computing device 102). At 906, method 900 can comprise employing, by the system, respective given possible goals for representative plans that correspond to the respective given possible goals (e.g., via a clustering component 306, an artificial intelligence planning component 208, a plan projector component 104, and/or a computing device 102). At 908, method 900 can comprise employing, by the system, respective representative plans as possible goals for clusters that do not have a given goal corresponding to a representative plan (e.g., via a clustering component 306, an artificial intelligence planning component 208, a plan projector component 104, and/or a computing device 102).

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

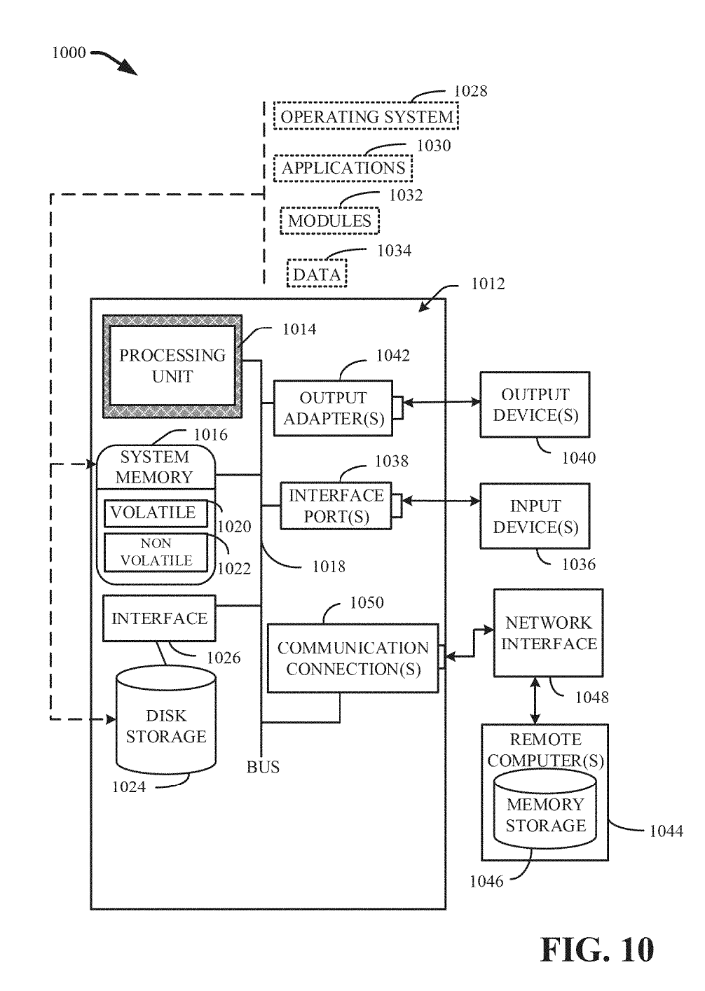

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1494), and Small Computer Systems Interface (SCSI). The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012. System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

In an embodiment, for example, computer 1012 can perform operations comprising: in response to receiving a query, selecting, by a system, a coarse cluster of corpus terms having a defined relatedness to the query associated with a plurality of coarse clusters of corpus terms; determining, by the system, a plurality of candidate terms from search results associated with the query; determining, by the system, at least one recommended query term based on refined clusters of the coarse cluster, the plurality of candidate terms, and the query; and communicating at least one recommended query term to a device associated with the query.

It is to further be appreciated that operations of embodiments disclosed herein can be distributed across multiple (local and/or remote) systems.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products, and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
in response to receiving a set of possible goals of an agent, a model of a domain, and a set of observations associated with the domain, transforming, by a system operatively coupled to a processor, a goal recognition problem into an artificial intelligence planning problem;
determining, by the system, a set of plans using an artificial intelligence planner on the artificial intelligence planning problem; and
determining, by the system, a probability distribution over the set of possible goals based on the set of plans.

2. The computer-implemented method of claim 1, further comprising, in response to determining that one or more observations are unreliable, discarding, by the system, the one or more observations that are unreliable.

3. The computer-implemented method of claim 1, further comprising, in response to determining that one or more observations are action conditions, transforming, by the system, the one or more observations that are action conditions into fluents.

4. The computer-implemented method of claim 1, further comprising, in response to determining that the set of possible goals is a partial set of possible goals, obtaining, by the system, a future time horizon for determining the set of plans and obtaining, by the system, a threshold for clustering.

5. The computer-implemented method of claim 1, further comprising, in response to determining that the set of possible goals comprises sequentially dependent goals, employing, by the system, a predicate representative of a done condition for one or more combinations of possible goals in the set of possible goals to determine the set of plans using the artificial intelligence planner on the artificial intelligence planning problem.

6. The computer-implemented method of claim 1, further comprising, in response to determining that the set of possible goals comprises sequentially independent goals:
transforming, by the system, the goal recognition problem into respective artificial intelligence planning problems for possible goals in the set of possible goals; and
employing, by the system, respective distinct predicates representative of a done condition for the artificial intelligence planning problems to determine sets of plans using the artificial intelligence planner on the artificial intelligence planning problems.

7. A computer-implemented method, comprising:
obtaining, by a device operatively coupled to a processor, a model of a domain;
obtaining, by the device, a set of observations associated with the domain;
obtain a set of possible goals of an agent operating in the domain;
transforming, by the device, a goal recognition problem into an artificial intelligence planning problem, wherein the goal recognition problem is associated with the set of possible goals of the agent, the model of a domain, and the set of observations associated with the domain;
determining, by the device, a set of plans using an artificial intelligence planner on the artificial intelligence planning problem; and
determining, by the device, a probability distribution over the set of possible goals based on the set of plans.

8. The computer-implemented method of claim 7, further comprising:
in response to a determination that the set of possible goals is a partial set of possible goals, obtaining, by the device, a future time horizon for determining the set of plans and obtain a threshold for clustering, wherein the determining the set of plans using the artificial intelligence planner on the artificial intelligence planning problem comprises determining the set of plans within the future time horizon.
